(19) United States
(12) Patent Application Publication
(10) Pub. No.: US 2023/0085898 A1
(43) Pub. Date: Mar. 23, 2023

(54) AUTOMATIC CROSS-SENSOR CALIBRATION USING OBJECT DETECTIONS

(71) Applicant: QUALCOMM Incorporated, San Diego, CA (US)

(72) Inventors: Daniel Hendricus Franciscus DIJKMAN, Haarlem (NL); Haitam BEN YAHIA, Diemen (NL); Sundar SUBRAMANIAN, San Diego, CA (US); Radhika Dilip GOWAIKAR, San Diego, CA (US)

(21) Appl. No.: 17/482,217

(22) Filed: Sep. 22, 2021

(51) Int. Cl. G01S 7/40; G01S 13/04; G01S 13/931; B60W 50/06; B60W 40/02

(52) U.S. Cl. CPC G01S 7/40; G01S 13/04; G01S 13/931; B60W 50/06; B60W 40/02; G01S 2013/9323; G01S 2013/9324; B60W 2420/52; B60W 2420/54; B60W 2554/4029

(57) ABSTRACT

Certain aspects of the present disclosure provide techniques for sensor calibration. First sensor data is received from a first sensor and second sensor data is received from a second sensor, where the first sensor data and the second sensor data each indicate detected objects in a space. The first sensor data is transformed using a first transformation profile to convert the first sensor data to a coordinate frame of the second sensor data. The first transformation profile is refined based on a difference between the transformed first sensor data and the second sensor data.

### INTRODUCTION

Aspects of the present disclosure relate to sensor calibration.

In a wide variety of modern systems, sensors can be used to detect the presence, location, orientation, or other characteristics of various objects in a physical space. Often, multiple individual sensors are used to detect objects in the space. Such use of multiple sensors can provide redundancy, increase the coverage area, provide more accurate detections, and the like. Further, in many cases, multiple different types of sensors are deployed to provide more robust detections.

For example, autonomous vehicles (e.g., self-driving cars and trucks) often rely on a variety of sensor components, including radio detection and ranging (radar) sensors, light detection and ranging (LIDAR) sensors, ultrasonic sensors, imaging sensors (e.g., cameras), global positioning sensors, and the like.

As each sensor in a common system typically has a unique location, a unique orientation, and unique intrinsic properties, the sensors must generally be calibrated such that their detections are aligned. Such calibration is tedious, prone to inaccuracy, and largely manual, requiring significant time and effort. Further, if any changes occur in the suite of sensors (e.g., if one or more sensors are displaced, such as due to vibrations) then the calibration must be restarted anew. As existing approaches generally require vast open areas (e.g., greater than one hundred meters in each direction) to calibrate object detection at a significant distance, existing recalibration techniques cannot practically be performed with any regularity.

Accordingly, improved techniques for automated sensor calibration are needed.

### BRIEF SUMMARY

Certain aspects provide a method, comprising: receiving first sensor data from a first sensor and second sensor data from a second sensor, wherein the first sensor data and the second sensor data each indicate detected objects in a space; transforming the first sensor data using a first transformation profile to convert the first sensor data to a coordinate frame of the second sensor data; and refining the first transformation profile based on a difference between the transformed first sensor data and the second sensor data.

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### BRIEF DESCRIPTION OF THE DRAWINGS

The appended figures depict certain aspects of the one or more aspects and are therefore not to be considered limiting of the scope of this disclosure.

FIG. 1 depicts an example collection of misaligned object detections and automated sensor calibration.

FIG. 2 depicts an example workflow for automated sensor calibration and profile refinement.

FIG. 3 depicts an example workflow for transforming and matching sensor data to perform automated cross-sensor calibration.

FIG. 4 is a flow diagram illustrating an example method for matching detected objects to perform automated cross-sensor calibration.

FIG. 5 is a flow diagram illustrating an example method for refining transformation profiles based on object distances.

FIG. 6 is a flow diagram illustrating an example method for refining transformation profiles based on time offsets.

FIG. 7 is a flow diagram illustrating an example method for refining transformation profiles.

FIG. 8 depicts an example processing system configured to perform various aspects of the present disclosure.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide techniques for automated cross-sensor calibration and transformation profile refinement based on object detections.

Generally, increasing the number and types of sensors can greatly enhance the perceptual information of an environment (e.g. using cameras, radar, and LIDAR on a vehicle). To assure that a single representation of the environment is generated, the various sensors must be calibrated to allow each individual perception to be aligned to a common representation or coordinate frame. For example, the system may calibrate multiple cameras using a detected object that is observed by multiple cameras. By using aspects of the present disclosure, the high demands of modern systems (such as autonomous vehicles) can be satisfied via automated and on-line calibration, which can leverage many more objects than manual efforts and can return much more accurate calibrations at much more frequent intervals.

In some aspects, object detections from sensor-specific detection algorithms are collected. For example, using deep learning, objects can be detected in images from one or more cameras. Similarly, using other algorithms or techniques, objects can be detected in radar data, LIDAR data, and the like. These detections may be characterized by a variety of characteristics depending on the particular sensors, capabilities, and system implementation. For example, the detections may characterize the detected object size(s), shape(s) dimension(s), position(s), orientation(s), confidence (e.g., the probability that the detection corresponds to a real object in the space), and the like. Notably, the detected object(s) in data from one sensor may or may not be aligned with detected object(s) in data from other sensors.

In some aspects, the system can transform the sensor data (e.g., the object detections) from the coordinate frame of one or more sensors to the domain or coordinate frame of a reference sensor, which can act as a ground truth for the system. This may be accomplished using, for example, transformation matrices (e.g. a rotation/projection matrix) with dynamically and automatically curated transformation parameters, trained neural networks, and the like. In one aspect, these transformations are performed using initial or un-calibrated transformation profiles. For example, the system may be initialized with a transformation profile for each sensor, with the assumption that the sensor has not changed significantly from the original setting. Over time, as discussed below, these profiles can be refined based on new data.

After the sensor data is transformed, in one aspect, the system can match the transformed detections to object detections in the reference sensor data using various matching techniques. For example, using the Hungarian algorithm to match bounding boxes based on intersection-over-union (IoU), the system can identify, for detected object(s) in a given set of (transformed) sensor data, corresponding object(s) in the reference sensor data.

Additionally, in some aspects, the system may use refinement techniques such as gradient descent algorithms to optimize the parameters of transformations. For example, the system may employ stochastic gradient descent using a distance loss function between the transformed detections and the reference detections. This allows the system to refine the transformation profiles, ensuring that subsequent sensor data can be accurately transformed to the reference coordinate frame.

Accordingly, aspects described herein overcome conventional limitations with sensor calibration, and improve the performance and accuracy of a variety of sensor suites.

### Example Environment with Misaligned Detections

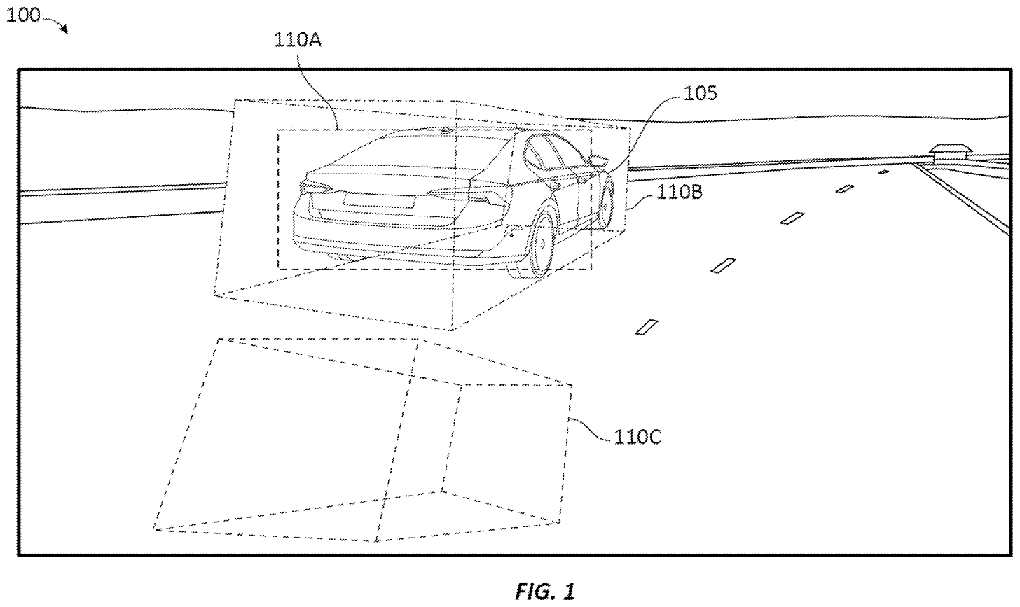

FIG. 1 depicts an example set of object detections prior to and subsequent to automated calibration. The illustrated environment 100 depicts sensor data from a system corresponding to a self-driving vehicle. For example, the depicted example may be an image captured by a camera on the self-driving vehicle. Though the illustrated example includes a self-driving vehicle, aspects of the present disclosure are readily applicable to any environment utilizing sensors to detect objects.

As illustrated, an object 105 is in a space visible to multiple sensors (e.g., cameras, LIDAR sensors, radar sensors, ultrasonic sensors, and the like). In the illustrated example, the object 105 is a car. In various aspects, the object 105 may generally be anything that is detectable sensors, such as a pedestrian, an obstacle, another vehicle, road markings, a sign, and the like.

In the illustrated example, a detection 110A corresponds to an object detection in the sensor data from a first sensor of the system. For example, if the sensor data is from a camera, then the box 110A may be a bounding box generated by processing the camera data using deep learning (or other image or object detection and/or recognition techniques) to identify objects.

As illustrated, other detections 110B and 110C are also present. These may be from additional sensors, or from the same sensor before and after automatic calibration using aspects described herein. For example, the detections 110B and 110C may correspond to one or more LIDAR sensors, radar sensors, ultrasonic sensors, and the like. As discussed above, the particular technique(s) used to generate object detections based on sensor data may vary depending on the particular sensor that provided the data.

In the illustrated example, though the detection 110C corresponds to the object 105, it is misaligned from the perspective of the camera's coordinate frame. That is, the detection 110C indicates that the object 105 is below (and oriented differently) than the location of the object in the reference coordinate frame (indicated by the detection 110A). This may occur, for example, because the sensor associated with the detection 110C has been displaced (such as due to vibrations or impact).

In an aspect, if the camera sensor is used as a reference coordinate frame, then the system may endeavour to transform other sensor coordinate frames to the camera coordinate frame. In aspects of the present disclosure, the system may therefore apply one or more transformations (e.g., indicated in a transformation profile) to translate the detection 110C (and other detections from the same sensor) to the reference coordinate frame associated with the detection 110A.

In various aspects, these transformations may include, for example, time offsets (to correct for different latencies or temporal offsets between sensors), rotation corrections (to correct for orientation errors), translation corrections (e.g., relocating detections in three-dimensional space), projection correction (e.g., to project a three-dimensional coordinate frame, such as in LIDAR data, to a two-dimensional coordinate frame, such as in camera data), and the like.

In the illustrated example, the detection 110B may correspond to the transformed detection 110C. That is, the detection 110B may be generated by transforming the detection 110C using the appropriate transformation profile. As illustrated, this detection 110B is much more closely aligned with the detection 110A (which was provided via a different sensor).

After applying such transformations, the system can use one or more matching techniques (such as intersection-over-union) to confirm that the detection 110C (transformed to the detection 110B) and detection 110A actually correspond to the same object 105. Subsequently, the system may refine the transformation profile to more accurately transform the detection 110C (and other detections in the coordinate frame of the misaligned sensor) to the frame of the reference sensor, based at least in part on how well aligned the detection 110B (the transformed version of the original detection 110C) and the ground truth detection 110A are. In some aspects, the transformation is applied to all object detections in the data, thereby reducing the set of possible transformations and the search space for the matching.

For example, in one aspect, the system may determine a distance between the detection 110A (in the reference frame) and the transformed detection 110B (after the transformation profile is applied). The system may then compute a loss using one or more loss functions based on this distance, and use this loss to refine the profile (e.g., using gradient descent). This ensures that subsequent transformations are more accurate. In this way, the sensors can be automatically calibrated.

In some aspects, as part of the transformation and matching process, the system may require at least some overlap between detections from different sensors for at least one point in time. In some aspects, if no detections overlap, then the system may apply one or more random transformations until one or more detections overlap, and use these random transformations as a starting point for the transformation profile.

In some aspects, the transformation profiles can be refined in an on-line fashion (e.g., using real detections of the system in real-time, near real-time, or periodically). In another aspect, the system may store these detections for subsequent processing (e.g., in batches during non-peak hours, or to be offloaded to other systems for processing).

By using such continuous refinement, the system provides accurate sensor calibration without requiring manual intervention. In at least one aspect, based on the transformation profiles, the system may infer that a sensor requires manual maintenance. For example, by comparing the current (refined) profile to an original profile (e.g., provided based on the original arrangement of sensors), the system may determine that one or more sensors have become displaced. Similarly, by monitoring how a transformation profile changes over time, the system may infer that the sensor(s) are currently being displaced (e.g., due to vibration from an untightened connection). In at least one aspect, therefore, the system may generate an alert or notification indicating which sensor is displaced. This may also indicate the needed corrections. In an aspect, such a notification can enable users to quickly and easily correct the displacements to return the system to its original condition.

### Example Workflow for Automated Sensor Calibration and Refinement

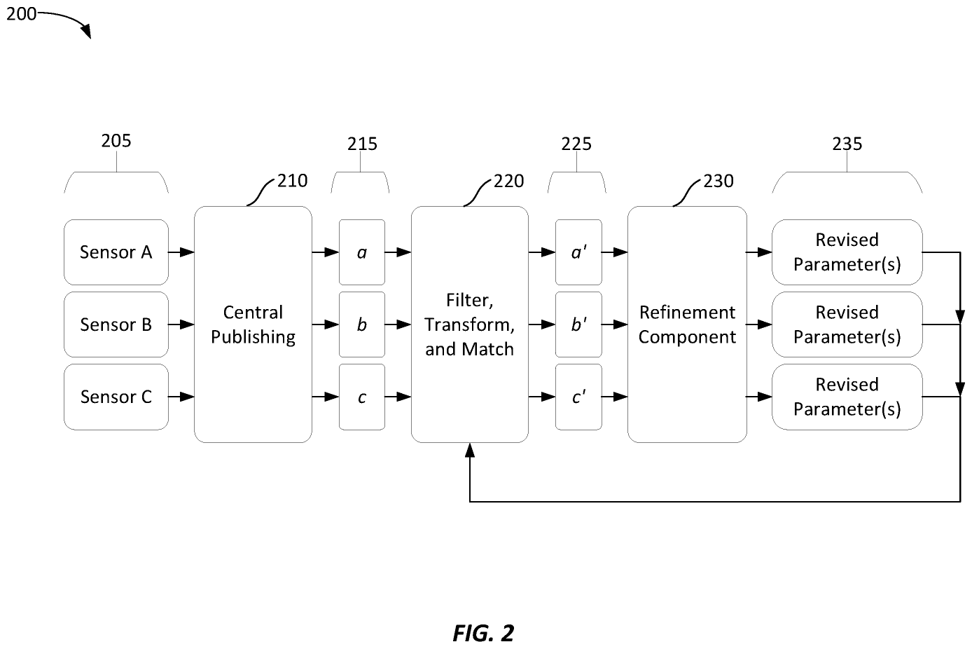

FIG. 2 depicts an example workflow 200 for automated sensor calibration and profile refinement.

In the illustrated workflow, a set of sensors 205 are used in a system to enable object detection. These sensors 205 may include, for example, LIDAR sensor(s), radar sensor(s), camera(s), ultrasonic sensor(s), global positioning sensor(s), and the like. Although three sensors 205 are depicted, in aspects, there may be any number of sensors 205 in the system.

As illustrated, each sensor 205 provides its respective sensor data via a central publishing system 210 (e.g., a data bus such as a controller area network (CAN) bus in a vehicle) that is used to transmit data among the various system components (e.g., from each sensor to a centralized processing component). In some aspects, the sensors 205 provide raw sensor data which can be processed by other components to identify object(s) in each set of sensor data. In another aspect, the sensor may include components to perform such object detection, and output the detections via the central publishing system 210.

In the workflow 200, the sensor data output by each respective sensor 205 yields an associated set of detections 215. That is, the detections labeled “a” may correspond to object detections from the sensor data provided by Sensor A, the detections labeled “b” may correspond to object detections from the sensor data provided by Sensor B, and the detections labeled “c” may correspond to object detections from the sensor data provided by Sensor C. Note that a one-to-one correspondence of sensors to detections is depicted for simplicity, but it is possible that a given sensor may be able to detect multiple simultaneous objects, and also that a given sensor may not be detecting any objects at a given time. Additionally, the set of detections from a first sensor may include more or fewer detections, as compared to a second set from a second sensor. For example, the set of detections from Sensor A (labeled “a”) may include more, fewer, or the same number of detections as the set of detections from Sensor B (labeled “b”).

Each set of detections 215 can generally include various characteristics depending in part on the particular implementation, as well as the particular sensor 205 associated with the detection. For example, some sensors (such as LIDAR) may provide three-dimensional meshes or bounding boxes, while others (such as cameras) can provide two-dimensional bounding boxes. As additional example characteristics, the detections 215 may indicate the distance(s) to each detected object, orientation(s) of the object(s), location(s) or position(s) of the objects, and the like.

As illustrated, in block 220, the system performs filtering, transformation, and matching for the detections 215.

In some aspects, filtering may be an optional step that can help improve the quality of the subsequent refinements to the transformation profiles. Generally, filtering may include removing one or more elements of the detection sets, or one or more entire detection sets (e.g., one or more detections 215 from one or more sets of sensor data) based on various criteria, including a confidence in the detection, a distance of the detection relative to the system or sensor (e.g., if the detected object is below a defined minimum distance or above a defined maximum distance), a position of the detection, relative to the sensor or system (for example, one sensor may have defined blackout areas where detections are ignored, such as due to distortion from a windshield), and the like.

After any appropriate filtering is applied, in block 220, the system can apply transformation profiles to each detection in order to align them to the same coordinate frame. Generally, the transformations can be configured to correct for a variety of factors, including windshield distortion, intrinsic sensor characteristics, two-dimensional and/or three-dimensional rotation, two-dimensional and/or three-dimensional translation, time offsets, and the like.

In one aspect, each sensor may be associated with a coordinate frame, and each pair of sensors may be associated with a transformation profile configured to transform data (e.g., object detections) between the first sensor and the second sensor's individual coordinate frame. That is, a first transformation profile may be used to transform detections 215 from the coordinate frame of Sensor A to the coordinate frame of Sensor B (and the inverse of the profile may transform detections from the coordinate frame of Sensor B to the coordinate frame of Sensor A), while a second transformation profile is used to transform detections from the coordinate frame Sensor A to the frame of Sensor C. In at least one aspect, the system may maintain a respective transformation profile, for each respective sensor, that transforms detections from the respective sensor to a reference coordinate frame (e.g., to the coordinate frame of a ground truth sensor).

In block 220, after the transformations are applied, as illustrated, the transformed detections can be matched with each other in the common (or reference) coordinate frame. For example, as discussed above, the system may use the Hungarian algorithm to match the detections, in order to identify, for each detection, a set of other detection(s) that correspond to the same object (in the same coordinate frame). In at least one aspect, matching the transformations includes identifying, for each detected object in the reference coordinate frame (e.g., in the sensor data from the reference sensor to which other sensors are being aligned), one or more corresponding detections (belonging to the same object) in transformed sensor data from other sensors.

As illustrated, the output from block 220 is a set of filtered, transformed, and matched detections 225, which are then provided to a refinement component 230 to compute one or more losses between the matched detections 225.

In some aspects, the sets of matched detections are the same size for each sensor 205. That is, the number of detections in the matched detections 225 from Sensor A (labeled “α′”), may be the same as the number of matched detections 225 from Sensor B (labeled “b′”) and the number of matched detections 225 from Sensor C (labeled “c′”). Stated differently, as the detections from different sensors have been matched in the matched detections 225 (at block 220), each set may have the same number of detections (e.g., because any detections found in one sensor data but not in another cannot be matched, and therefore can be ignored during the refining process). In some aspects, these unmatched detections can nevertheless be transformed using the transformation profiles, in order to align them to the reference coordinate frame.

In one aspect, the refinement component 230 computes, for pairs of matched detections 225, the distance between the detections (e.g., between the original detection in the ground truth data or reference coordinate frame and a transformed detection from a different sensor). This may include, for example, the angular offset(s) (e.g., if the transformed detection differs in orientation), spatial offset (e.g., if the transformed detection differs in location in two or three-dimensional space), and the like.

In some aspects, the refinement component 230 can generate a temporal loss for the matched detections 225. For example, suppose a given sensor 205 has a delay or latency relative to a reference sensor. In such a case, the relevant transformation profile may include a time offset (e.g., buffering the sensor data from the given sensor 205 for some period of time). In one such aspect, the refinement component 230 may compute a loss corresponding to how far this current offset differs from the optimal time offset.

As illustrated, the computed loss(es) can be used to generate or refine the transformation profiles, resulting in revised parameter(s) 235 for each sensor 205. The revised parameters 235 may generally correspond to refined transformation profiles used to transform the detections 215 from a given sensor 205.

In various aspects, the refinement process may include a variety of techniques depending on the implementation of the underlying transformation profiles. For example, the system can use gradient descent to refine the transformation profile. In some aspects where the transformation includes use of a neural network, backward-propagation may be used to refine the network.

In the illustrated workflow 200, the revised parameters are returned, provided, or fed back to block 220 for use in transforming subsequent detections 215 more accurately.

### Example Workflow for Transforming and Aligning Sensor Data

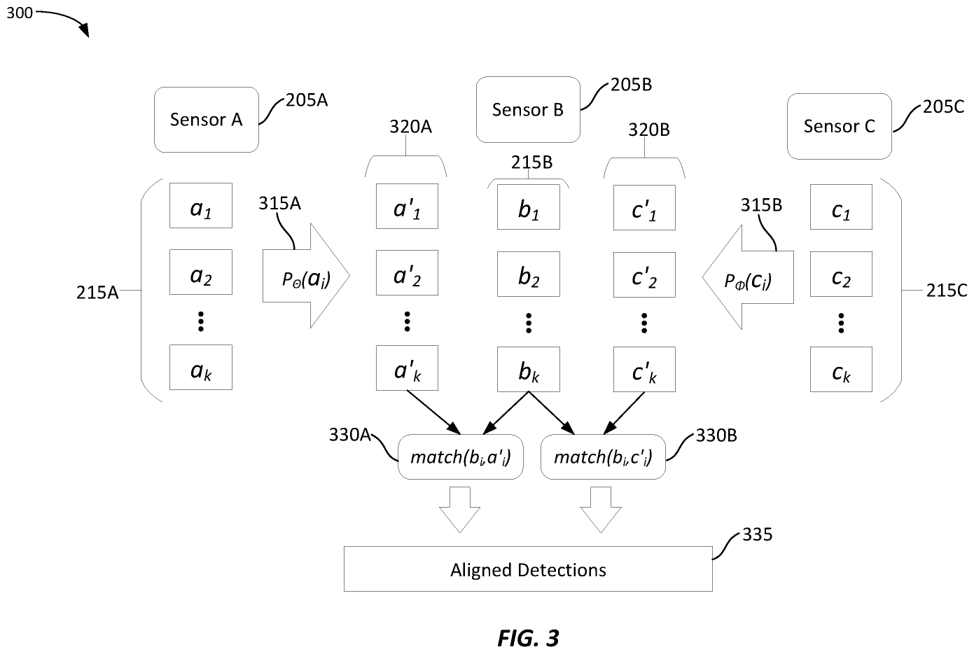

FIG. 3 depicts an example workflow 300 for transforming and aligning sensor data to perform automated cross-sensor calibration.

In the illustrated workflow 300, detections 215 are provided by three sensors 205. Specifically, sensor 205A (labeled “Sensor A”) provides detections 215A as a set of detections {α₁, α₂, αₖ}, sensor 205B (labeled “Sensor B”) provides detections 215B as a set of detections {b₁, b₂, bₖ}, and sensor 205C (labeled “Sensor C”) provides detections 215C as a set of detections {c, c₂, cₖ}. Though the illustrated example includes k detections in each set of detections 215 for conceptual clarity, there may be any number of objects in each set of detections 215. That is, the number of detections 215 from a given sensor 205 may include more, fewer, or the sane number of detections 215 from any other sensor 205. As discussed above, in some aspects, detections that cannot be matched (e.g., because they exist only in the sensor data from one sensor) can still be transformed using the relevant transformation profile(s) for the sensor, allowing them to be placed in the same reference coordinate frame.

Generally, each detection αᵢ, bᵢ, and cᵢ corresponds to an identified object in the respective sensor data provided by the corresponding sensor 205A, 205B, or 205C. In aspects, the detections 215A-C may generally include a variety of characteristics, including bounding boxes for the object in the data, three-dimensional meshes, location(s), orientation(s), distances, and the like.

In the illustrated workflow 300, the sensor 205B acts as the reference sensor. That is, the coordinate frame of the sensor 205B is used as the “ground truth” frame, and the detections 215A and 215C are transformed to align to this coordinate frame. Further, in computing losses and refining the transformation profiles, the transformed detections 320A and 320C will each be compared to the detections 215B. In aspects, however, any sensor (or a coordinate frame not associated with any sensor) may be used as the reference frame. Additionally, there may be multiple reference coordinate frames in some aspects. For example, the detections from sensor 205B may be transformed to the coordinate frame of the sensor 205A (using a first transformation profile), and also transformed to the coordinate frame of sensor 205C (using a second transformation profile).

As illustrated, the detections 215A are transformed using a transformation operation 315A according to P_{Θ}(αᵢ), where P is a set of transformations (e.g., projection, translation, rotation, and/or time offset) defined by learned parameters Θ, and αᵢ is the i-th detection in the set of detections 215A. This results in transformed detections 320A, labeled {α′₁, α′₂, α′ₖ}. In an aspect, the learned transformation parameters Θ are specific and unique to the sensor 205A and sensor 205B pair. That is, the parameters Θ are used to transform sensor data from the coordinate frame of the sensor 205A to the coordinate frame of the sensor 205B, and are not applicable to sensor data from other coordinate frames.

Similarly, as illustrated, the detections 215C are transformed using a transformation operation 315B according to P_{Φ}(cᵢ), where P is the defined set of transformations (e.g., projection, translation, rotation, and/or time offset), Φ is the learned/trained transformation parameters, and cᵢ is the i-th detection in the set of detections 215C. This results in transformed detections 320B, labeled {c′₁, c′₂, c′ₖ}.

In the workflow 300, as indicated by block 330A, the transformed detections 320A are matched with the detections 215B according to match(bᵢ, α′ᵢ), where match(.) is some matching or alignment technique (e.g., the Hungarian algorithm). Similarly, as indicated by block 330B, the transformed detections 320B are matched with the detections 215B according to match(bᵢ, c′ᵢ). In some aspects, intersection-over-union techniques are used to measure the overlap, which can serve as a scoring function to evaluate how well the detections (e.g., matched via the Hungarian algorithm) overlap.

Though the matching function is described as matching the i-th detection in each set (e.g., the αᵢ detection and the bᵢ detection), it is to be understood that in some aspects, the matching detections may be at different indices or timestamps in differing sensor data. For example, the i-th detection in the transformed sensor data 320A (αᵢ) may in fact correspond to the h-th detection in the sensor data 215B (bₕ) (e.g., due to time offsets between the detections, due to the number of objects each sensor detected, and the like.

In one aspect, as discussed above, this matching may be performed by identifying, for each detection bᵢ in the set of detections 215B (the detections from the reference sensor), a corresponding detection α′ᵢ in the transformed detections 320A and/or a corresponding detection c′ₜ in the transformed detections 320B. In some aspects, note that it remains possible that some (or all) of the transformed detections 320A and 320B are not present in the detections 215B. In some aspects, as discussed above, these detections can be placed in the reference coordinate frame, but cannot be matched to other objects and may not be used to refine the profiles. As illustrated, the identified sets of corresponding matched detections are provided as the aligned detections 335, which allows the system to more accurately respond to detected objects using calibrated sensor data. In some aspects, the aligned detections 335 can also include the transformed, but unmatched, detections in the reference coordinate frame.

In some aspects, the reference sensor 205B is selected at least in part because it is configured to provide detections for any object detected by the sensors 205A and 205C. That is, for any detection 215A and 215C, there will be a corresponding detection 215B. For example, the sensor 205A may be a forward-facing sensor while the sensor 205C is rear-facing, and the sensor 205B may be a roof-mounted sensor that can detect objects both to the forward and the rear. This can allow the sensors to be aligned to a common coordinate frame. In some aspects, there may be one or more detections from the reference sensor 205B that are not detected by the other sensors 205A and 205C. Similarly, in some aspects, there may be detections from the sensors 205A or 205C that are not present in the data from the reference sensor 205B.

In some aspects, however, there may be multiple reference coordinate frames in use. For example, a first sensor may be used as the reference coordinate frame for all forward-facing sensors, while a second sensor is used as the reference coordinate frame for rear-facing sensors. Any number of sensors may be used as reference sensors for particular sensing fields, such as forward, backward, side, above, below, etc. Accordingly, in some aspects, sensor data from a given sensor (e.g., a roof-mounted sensor with 360 degree visibility) may be transformed into a different reference coordinate frame (using different transformation profiles) based at least in part on where each detection is (e.g., detections determined to be ahead of the vehicle may be transformed to the forward-facing coordinate frame, while detections behind the vehicle are transformed to the rear-facing coordinate frame).

Additionally, in some aspects, the reference coordinate frame may correspond to an arbitrary-defined universal domain, rather than any particular sensor. In one such aspect, for example, the detections from all sensors may be transformed to the universal coordinate frame in order to be aligned.

In some aspects, the workflow 300 may be used to align sensors from different objects (e.g., sensors on different vehicles). In one such aspect, a global positioning sensor may be used to enable transformation of sensor data from one vehicle to another. This can allow the system to refine the transformation profile from each sensor to the corresponding GPS sensor. In this way, sensor data from multiple vehicles can be combined into a single coherent world frame, and thereby used to refine transformation profiles.

For example, a first sensor (e.g., sensor 205A) may be rigidly attached to a first GPS sensor (e.g., on the same vehicle) and a second sensor (e.g., sensor 205C) may be rigidly attached to a second GPS sensor on a second vehicle. Using techniques described herein, the detected objects from the first sensor data (e.g., detections 215A) can be transformed, using the GPS data from the first GPS sensor and the GPS data from the second GPS sensor (which are already aligned), from the coordinate frame of the first sensor to the coordinate frame of the second sensor.

Further, in some aspects, the transformation profile for transforming the first sensor frame to the first GPS sensor frame, as well as the transformation profile for transforming from the second sensor to the second GPS sensor, can be refined using the detected objects, as discussed above.

### Example Method for Matching Detected Objects

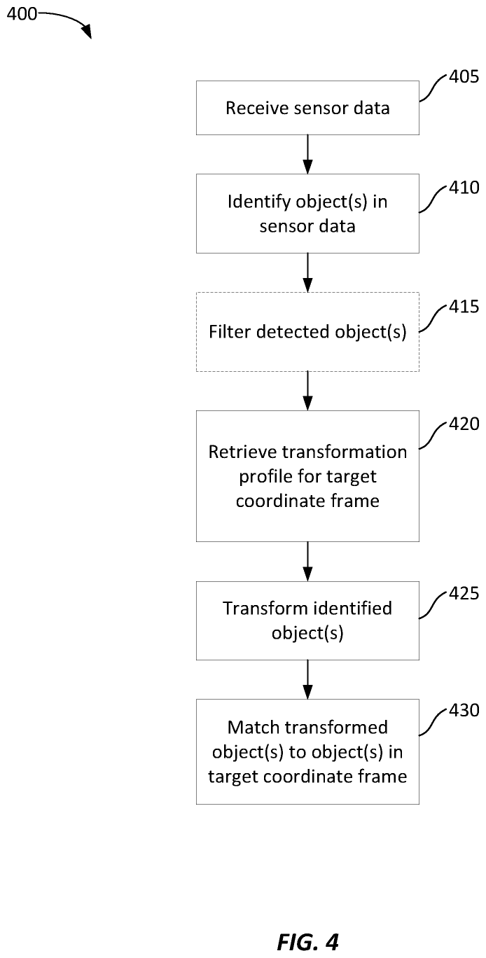

FIG. 4 is a flow diagram illustrating an example method 400 for matching detected objects to perform automated cross-sensor calibration.

The method 400 begins at block 405, where a sensor system receives sensor data from a sensor device, where the sensor device is part of a set of one or more sensors. The nature and character of the sensor data may differ based at least in part on the configuration of the underlying sensor. For example, a camera sensor may provide image data, while an ultrasonic sensor provides ranging data. Generally, the received sensor data can include some indication of object(s) within the detection range of the sensor, either explicitly or implicitly (e.g., encoded in the data). As discussed above, these indications can include the position or location of each object, the distance to each object, the orientation of each object, and the like.

At block 410, the sensor system identifies the one or more objects in the received sensor data. As discussed above, the particular techniques and algorithms used to extract these detected objects may vary depending on the particular configuration of the sensor. For example, a convolutional neural network may be used to detect objects in image data from a camera sensor.

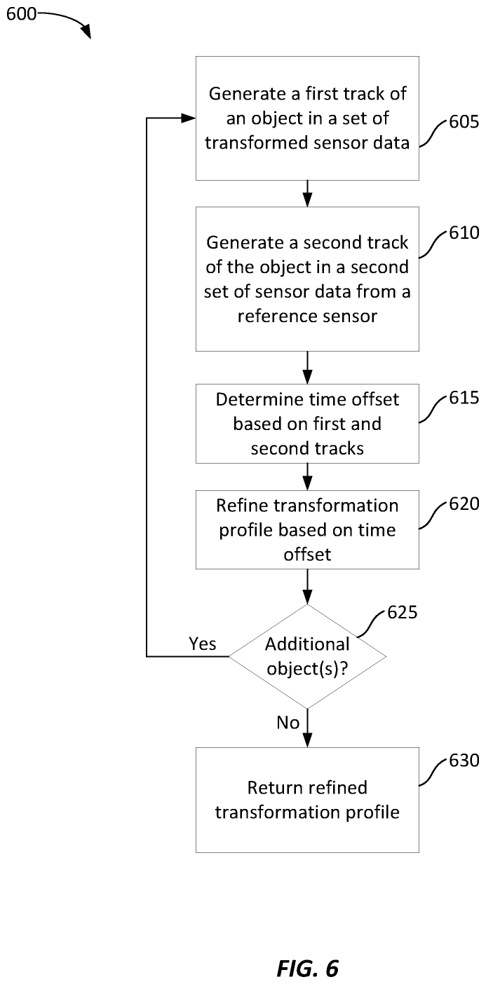

At block 415, the sensor system can optionally filter the detected objects in the received sensor data. For example, as discussed above, the system may filter out detected objects that are associated with a confidence below some defined threshold. In one aspect, the sensor system filters out detections that are above a predefined maximum distance, below a defined minimum distance, or otherwise in a predefined region or position for exclusion (e.g., due to distortions in the data, or uncertainty in the accuracy of detections at very large and/or very small distances). In some aspects, the filtering criteria includes consideration of object tracking over time, as discussed in more detail below with reference to FIG. 6. For example, the sensor system may discard detections that cannot be tracked for some minimum amount of time or a minimum number of frames (e.g., to avoid false positives or detection of objects that are mostly occluded).

Advantageously, filtering out such detections may improve the (eventual) refinement of the transformation profile, as suspect or potentially inaccurate sensor data can be ignored.

At block 420, the sensor system retrieves the relevant transformation profile associated with the sensor (that provided the sensor data) and the target coordinate frame. In some aspects, as discussed above, the sensor system may maintain a respective transformation profile for each respective sensor, where each respective transformation profile can be used to convert sensor data from the respective sensor to the target coordinate frame. If multiple reference coordinate frames are used, then multiple transformation profiles may be associated with a given sensor.

At block 425, the sensor system transforms the identified object detection(s) in the sensor data using the retrieved transformation profile. As discussed above, this may include, for example, applying one or more projection transformations, translations, orientation changes, time offsets, and the like.

At block 430, the sensor system matches the transformed object detection(s) from the sensor data to one or more object detection(s) in the target coordinate frame. In one aspect, this includes matching the transformed detections to detections from the sensor that is associated with the target coordinate frame. In another aspect, this matching may include matching the transformed detections from a first sensor with transformed detections from a second sensor (e.g., where neither the first nor the second sensor are associated with the target coordinate frame). These matched and aligned detections can then be returned.

### Example Method for Refining Transformation Profiles Using Detection Distance

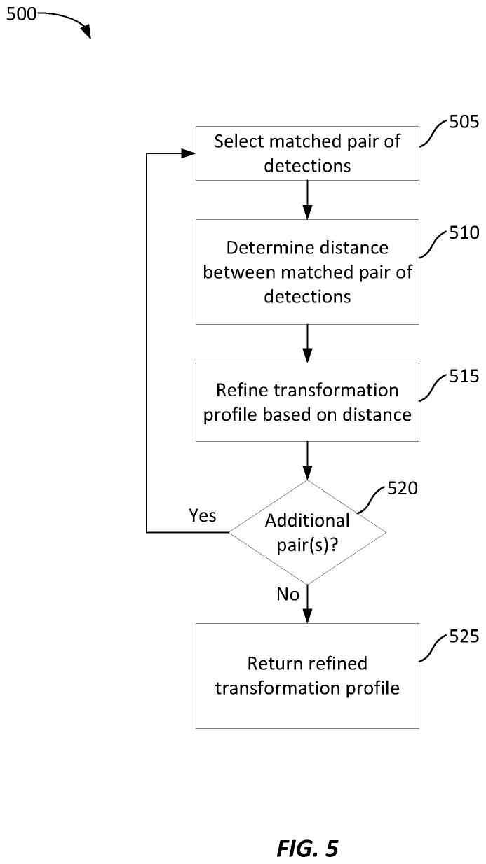

FIG. 5 is a flow diagram illustrating an example method 500 for refining transformation profiles based on detection distances.

In some aspects, the method 500 is performed continuously (e.g., as new object detections are matched, such as by using the method 400 of FIG. 4). In some aspects, the method 500 may be performed periodically (e.g., daily) based on aligned detections from the current period. The method 500 generally enables refinement of a transformation profile for a given sensor that is being calibrated.

The method 500 begins at block 505, where a sensor system selects a matched pair of detections from two different sensors. In some aspects, the sensor system may select a set of matched detections from three or more sensors. Each set (or pair) of matched detections corresponds to at least one transformed detection from a sensor that is being calibrated (e.g., for which the transformation profile is being refined), and at least one detection acting as a ground truth in the target coordinate frame (e.g., a detection from the reference sensor in the reference frame, or another transformed detection).

In some aspects, the matched detections are identified and grouped based on one or more alignment or matching techniques, such as intersection-over-union, as discussed above.

At block 510, the sensor system determines the distance between the detections in the matched set, with respect to the target coordinate frame. For example, the system may determine how far the transformed detection (or each of the transformed detections) is from the reference detection (e.g., the number of feet or meters in a three-dimensional coordinate frame, or the number of pixels in a two-dimensional coordinate frame). In some aspects, the system may further determine the orientation or angular offsets between the detections. Generally, determining the distance between detections may be performed in a variety of ways, including determining the distance between the centers of each, the distance(s) between the maximum or exterior points of each detection (e.g., the edges of a three-dimensional mesh or a bounding box), and the like.

At block 515, the sensor system refines the transformation profile of the sensor that is being calibrated based on the determined distance. In some aspects, this includes computing a loss and using the loss to refine the profile (e.g., via gradient descent). Although the illustrated example depicts refining the profile individually for each pair of detections (e.g., using stochastic gradient descent), the system may additional or alternatively refine the profile based on a batch of matched pairs (e.g., using batch gradient descent).

At block 520, the sensor system determines whether there is at least one additional pair (or set) of matched detections that has not yet been used to refine the transformation profile. If so, then the method 500 returns to block 505 to select another pair.

Though the illustrated example includes refining the transformation profile individually for each pair of detections for conceptual clarity, in some aspects, the profile is additionally or alternatively refined based on multiple pairs of detections jointly. That is, the sensor system may optimize the transformation profile based on a batch of multiple detections (over time or space) to improve accuracy. In some aspects, the sensor system refines the profiles based on all pairs of detections across time and space.

If no additional detections remain to calibrate the sensor, the method 500 continues to block 525, where the sensor system returns the refined transformation profile. This refined profile can subsequently be used to transform sensor data to enable accurate and aligned object detections across a suite of sensors. Generally, after each refinement step, the transformation profile may be able to transform detections to the reference coordinate frame more accurately (e.g., with less error to the ground truth detections), enabling robust automated sensor calibration.

### Example Method for Refining Transformation Profiles Using Time Offset

FIG. 6 is a flow diagram illustrating an example method 600 for refining transformation profiles based on time offsets.

In some aspects, the method 600 is performed continuously (e.g., as new object detections are matched, such as by using the method 400 of FIG. 4). In some aspects, the method 600 may be performed periodically (e.g., daily) based on aligned detections from the current period. The method 600 generally enables refinement of a transformation profile for a given sensor that is being calibrated.

The method 600 begins at block 605, where a sensor system generates a first track for an object detection in a first set of transformed sensor data. In at least one aspect, the transformed sensor data includes a sequence of frames or timestamps, each including zero or more detections, where the detections have been transformed to the reference coordinate frame of the system.

In one aspect, generating the track includes determining, in each of the sensor data frames, the location of a given object detection (if present). For example, using similar alignment techniques to those used to match corresponding objects in sensor data from different sensors (such as the Hungarian algorithm or intersection-over-union), the system can match detections in two or more adjacent frames of sensor data from the same sensor (e.g., because they move only a small amount between frames, and therefore likely correspond to the same object).

In at least one aspect, the sensor system can evaluate the quality of the generated track before proceeding with the method 600. For example, the system may determine whether any frames are missing (that is, whether there are any portions of time where a detection is not found in the sensor data), whether the track appears to jump or move suddenly (e.g., because the system mistakenly included a different object detection as part of the track), whether the track, from beginning to end, covers at least a minimum amount of time or number of frames, and the like. In one such aspect, tracks failing to meet the quality criteria may be discarded, rather than used to refine the transformation profile(s).

At block 610, the sensor system can generate a second track for the object using a second set of sensor data from another sensor (e.g., the reference sensor in the target coordinate frame). That is, for the object used to generate the first track, the sensor system can identify a corresponding detection of the same object in the second set of sensor data (e.g., using various matching techniques as discussed above). The sensor system can then generate a track of this detection in the second set of sensor data, as discussed above.

As a result, the sensor system has two tracks for motion, from separate sensors, of the same object over time, both in the reference coordinate frame. At block 615, based on these tracks, the sensor system determines the correct time offset between the sensors. That is, the sensor system can determine whether the data from either sensor should be buffered (and for how long) based on a delay or lag between the location of the object in each track at one or more timestamps.

In some aspects, each track may have differing timestamps or frames, based at least in part on the configuration of the sensors. For example, a given camera sensor may provide thirty frames of data per second, while a given RADAR sensor provides ten frames per second. In some aspects, there may be few (or no) frames that include the detected object at the same timestamp in both tracks.

Therefore, in some aspects, in order to determine the appropriate time offset, the system can use an interpolation operation on one or both tracks to determine or infer the location of the object at one or more specific defined timestamps. That is, given a set of detections α={α₂, αₘ} (each detection corresponding to a single object in a single frame of sensor data), a set of corresponding timestamps t={t₁, t₂, . . . , tₘ} (one timestamp for each detection), and a timestamp T where the inferred object location is desired, the system may use an operation, such as interpolate(α, t, T) that returns the inferred location of the object at time T.

In one aspect, interpolate(α, t, T) is a linear interpolation defined as ((1−λ)*αₜ₁+λ*αₜ₂), where

$$λ = ( \frac{T - t 1}{t 2 - t 1} ) ,$$

αₜ₁ is the location of the detection at time and αₜ₂ is the location of the detection at time t2. Thus, the system may return the location of the detection at time T using linear interpolation of detections.

In some aspects, the system may use such interpolation for one or multiple tracks to determine the object location at a one or more specific times in each track. Based on such interpolations, the system can determine the proper time offset (e.g., the offset that should be added to either track to ensure the detections align in time and space).

At block 620, the sensor system refines the transformation profile (used to transform the first set of sensor data) based on the determined offset. Although the illustrated example depicts refining the profile individually for each pair of tracks, the system may additionally or alternatively refine the profile based on a batch of tracks. For example, the sensor system may determine a respective time offset based on respective trackings for each respective object in each set of sensor data. The system may then aggregate (e.g., average) these offsets to determine the overall time offset.

In the illustrated example, at block 625, the sensor system determines whether there is at least one additional object in the first set of sensor data that has not yet been tracked. If so, then the method 600 returns to block 605 to be performed for a new object. If not, then the method 600 continues to block 630, where the sensor system returns the refined transformation profile for the first sensor, including an updated time offset.

Though the illustrated example includes refining the transformation profile individually for each pair of detections for conceptual clarity, in some aspects, the profile is additionally or alternatively refined based on multiple pairs of detections jointly. That is, the sensor system may optimize the transformation profile based on a batch of multiple detections (over time or space) to improve accuracy. In some aspects, the sensor system refines the profiles based on all pairs of detections across time and space. Based on such updates, the transformation profile may be able to transform detections to the reference coordinate frame more accurately (e.g., with less temporal error to the ground truth detections), enabling robust automated sensor calibration.

### Example Method for Refining Transformation Profiles

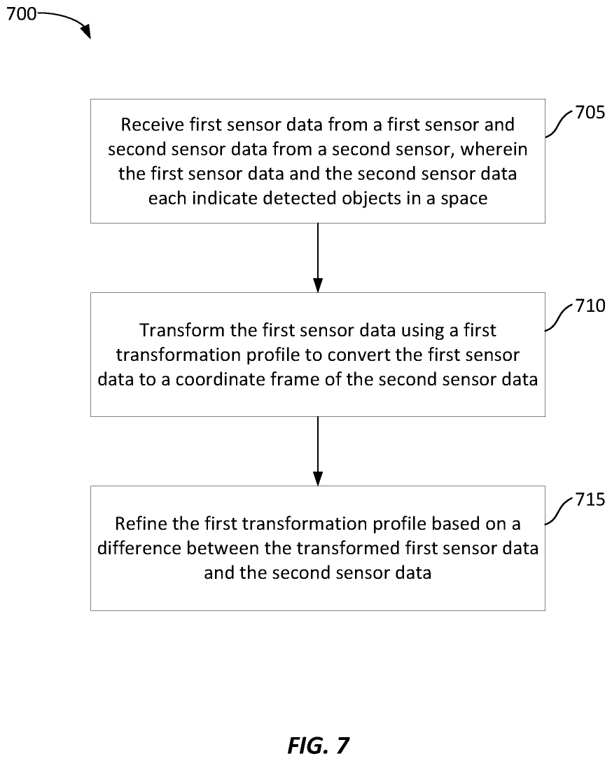

FIG. 7 is a flow diagram illustrating an example method 700 for refining transformation profiles.

At block 705, first sensor data is received from a first sensor and second sensor data from a second sensor, wherein the first sensor data and the second sensor data each indicate detected objects in a space.

At block 710, the first sensor data is transformed using a first transformation profile to convert the first sensor data to a coordinate frame of the second sensor data.

In some aspects, the method 700 further comprises, prior to transforming the first sensor data, filtering one or more detected objects from the first sensor data based on one or more filtering criteria. In some aspects, the filtering criteria specifies a position of detected objects.

In some aspects, the method 700 further comprises, subsequent to transforming the first sensor data, matching a first detected object in the transformed first sensor data to a second detected object in the second sensor data using one or more matching techniques. In some aspects, matching the first detected object to the second detected object is performed using a Hungarian algorithm. In some aspects, matching the first detected object to the second detected object is performed upon determining that the first detected object and the second detected object both correspond to a single object.

In some aspects, the first transformation profile comprises at least one of: a time offset, a rotation correction, a translation correction, or a projection correction.

At block 715, the first transformation profile is refined based on a difference between the transformed first sensor data and the second sensor data.

In some aspects, refining the first transformation profile comprises computing a loss between the transformed first sensor data and the second sensor data and using gradient descent to refine the first transformation profile. In some aspects, computing the loss comprises computing a distance between a first object in the transformed first sensor data and a second object in the second sensor data.

In some aspects, the method 700 further comprises generating a first track based on a location of a first object in two or more frames of the transformed first sensor data, generating a second track based on a location of the first object in two or more frames of the second sensor data, determining a time offset based on the first and second tracks, and further refining the first transformation profile based on the time offset.

In some aspects, the method 700 further comprises receiving third sensor data from a third sensor, and transforming the third sensor data using a second transformation profile to convert the third sensor data to the coordinate frame of the second sensor data.

In some aspects, the first sensor and second sensor are associated with a vehicle, and the detected objects in the space comprise at least one of: another vehicle, a pedestrian, an obstacle, or a road marking.

In some aspects, the first sensor and the second sensor are of a plurality of sensors, and the plurality of sensors comprise at least one of: a light detection and ranging (LIDAR) sensor, a radio detection and ranging (radar) sensor, an ultrasonic sensor, a camera, or a global positioning sensor.

In some aspects, detected objects in the first sensor data are characterized by bounding boxes indicating, for each detected object, one or more of: a size, a position, a rotation, or a confidence value.

### Example Processing System for Sensor Calibration

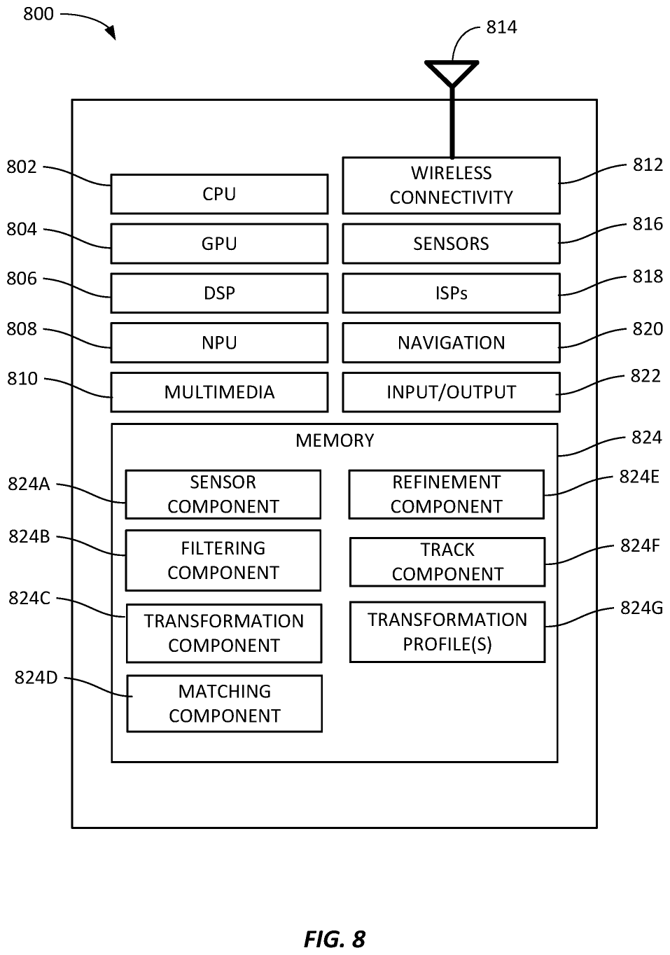

In some aspects, the workflows, techniques, and methods described with reference to FIGS. 1-7 may be implemented on one or more devices or systems. FIG. 8 depicts an example processing system 800 configured to perform various aspects of the present disclosure, including, for example, the techniques and methods described with respect to FIGS. 1-7.

Processing system 800 includes a central processing unit (CPU) 802, which in some examples may be a multi-core CPU. Instructions executed at the CPU 802 may be loaded, for example, from a program memory associated with the CPU 802 or may be loaded from a memory partition 824.

Processing system 800 also includes additional processing components tailored to specific functions, such as a graphics processing unit (GPU) 804, a digital signal processor (DSP) 806, a neural processing unit (NPU) 808, a multimedia processing unit 810, and a wireless connectivity component 812.

An NPU, such as 808, is generally a specialized circuit configured for implementing all the necessary control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing units (TPU), neural network processor (NNP), intelligence processing unit (IPU), vision processing unit (VPU), or graph processing unit.

NPUs, such as 808, are configured to accelerate the performance of common machine learning tasks, such as image classification, machine translation, object detection, and various other predictive models. In some examples, a plurality of NPUs may be instantiated on a single chip, such as a system on a chip (SoC), while in other examples they may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process it through an already trained model to generate a model output (e.g., an inference).

In one implementation, NPU 808 is a part of one or more of CPU 802, GPU 804, and/or DSP 806.

In some examples, wireless connectivity component 812 may include subcomponents, for example, for third generation (3G) connectivity, fourth generation (4G) connectivity (e.g., 4G LTE), fifth generation connectivity (e.g., 5G or NR), Wi-Fi connectivity, Bluetooth connectivity, and other wireless data transmission standards. Wireless connectivity processing component 812 is further connected to one or more antennas 814.

Processing system 800 may also include one or more sensors 816 (or sensor processing units) associated with any manner of sensor (such as radar sensors, LIDAR sensors, ultrasonic sensors, and the like), one or more image signal processors (ISPs) 818 associated with any manner of image sensor, and/or a navigation processor 820, which may include satellite-based positioning system components (e.g., GPS or GLONASS) as well as inertial positioning system components.

Processing system 800 may also include one or more input and/or output devices 822, such as screens, touch-sensitive surfaces (including touch-sensitive displays), physical buttons, speakers, microphones, and the like.

In some examples, one or more of the processors of processing system 800 may be based on an ARM or RISC-V instruction set.

Processing system 800 also includes memory 824, which is representative of one or more static and/or dynamic memories, such as a dynamic random access memory, a flash-based static memory, and the like. In this example, memory 824 includes computer-executable components, which may be executed by one or more of the aforementioned processors of processing system 800.

In particular, in this example, memory 824 includes sensor component 824A, filtering component 824B, transformation component 824C, matching component 824D, refinement component 824E, and track component 824F. The depicted components, and others not depicted, may be configured to perform various aspects of the techniques described herein. Though depicted as discrete components for conceptual clarity in FIG. 8, sensor component 824A, filtering component 824B, transformation component 824C, matching component 824D, refinement component 824E, and track component 824F may be collectively or individually implemented in various aspects, and may be implemented using hardware, software, or a combination of hardware and software

Generally, processing system 800 and/or components thereof may be configured to perform the methods described herein. For example, sensor component 824A may receive sensor data and extract or identify object detections in the sensor data. Filtering component 824B may filter the detections based on filtering criteria, as discussed above. Transformation component 824C can use transformation profiles 824G to transform sensor data to different coordinate frames, as discussed above.

Matching component 824D may use one or more techniques (such as intersection over union) to identify matching detections in differing sensor data. Refinement component 824E may be used to compute losses and refine the transformation profiles, as discussed above. Track component 824F may be used to generate tracks to determine proper time offsets, as discussed above.

Notably, in other embodiments, aspects of processing system 800 may be omitted, such as where processing system 800 is a server computer or the like. For example, multimedia component 810, wireless connectivity 812, sensors 816, ISPs 818, and/or navigation component 820 may be omitted in other embodiments. Further, aspects of processing system 800 may be distributed between multiple devices.

### Example Clauses

Clause 1: A method, comprising: receiving first sensor data from a first sensor and second sensor data from a second sensor, wherein the first sensor data and the second sensor data each indicate detected objects in a space; transforming the first sensor data using a first transformation profile to convert the first sensor data to a coordinate frame of the second sensor data; and refining the first transformation profile based on a difference between the transformed first sensor data and the second sensor data.

Clause 2: The method according to Clause 1, further comprising prior to transforming the first sensor data, filtering one or more detected objects from the first sensor data based on one or more filtering criteria.

Clause 3: The method according to any one of Clauses 1-2, wherein the filtering criteria specifies a position of detected objects.

Clause 4: The method according to any one of Clauses 1-3, further comprising subsequent to transforming the first sensor data, matching a first detected object in the transformed first sensor data to a second detected object in the second sensor data using one or more matching techniques.

Clause 5: The method according to any one of Clauses 1-4, wherein matching the first detected object to the second detected object is performed using a Hungarian algorithm.

Clause 6: The method according to any one of Clauses 1-5, wherein matching the first detected object to the second detected object is performed upon determining that the first detected object and the second detected object both correspond to a single object.

Clause 7: The method according to any one of Clauses 1-6, wherein refining the first transformation profile comprises: computing a loss between the transformed first sensor data and the second sensor data; and using gradient descent to refine the first transformation profile.

Clause 8: The method according to any one of Clauses 1-7, wherein computing the loss comprises computing a distance between a first object in the transformed first sensor data and a second object in the second sensor data.

Clause 9: The method according to any one of Clauses 1-8, further comprising: generating a first track based on a location of a first object in two or more frames of the transformed first sensor data; generating a second track based on a location of the first object in two or more frames of the second sensor data; determining a time offset based on the first and second tracks; and further refining the first transformation profile based on the time offset.

Clause 10: The method according to any one of Clauses 1-9, wherein the first transformation profile comprises at least one of: a time offset, a rotation correction, a translation correction, or a projection correction.

Clause 11: The method according to any one of Clauses 1-10, further comprising: receiving third sensor data from a third sensor; and transforming the third sensor data using a second transformation profile to convert the third sensor data to the coordinate frame of the second sensor data.

Clause 12: The method according to any one of Clauses 1-11, wherein the first sensor and second sensor are associated with a vehicle, and wherein the detected objects in the space comprise at least one of: another vehicle, a pedestrian, an obstacle, or a road marking.

Clause 13: The method according to any one of Clauses 1-12, wherein the first sensor and the second sensor are of a plurality of sensors, and wherein the plurality of sensors comprise at least one of: a light detection and ranging (LIDAR) sensor, a radio detection and ranging (radar) sensor, an ultrasonic sensor, a camera, or a global positioning sensor.

Clause 14: The method according to any one of Clauses 1-13, The method of claim 1, wherein detected objects in the first sensor data are characterized by bounding boxes indicating, for each detected object, one or more of: a size, a position, a rotation, or a confidence value.

Clause 15: The method according to any one of Clauses 1-14, wherein: the first sensor is rigidly attached to a first global positioning system (GPS) sensor, and the second sensor is rigidly attached to a second GPS sensor.

Clause 16: The method according to any one of Clauses 1-15, wherein transforming the first sensor data to convert the first sensor data to the coordinate frame of the second sensor data is performed using GPS sensor data from the first GPS sensor and GPS sensor data from the second GPS sensor.

Clause 17: A system, comprising: a memory comprising computer-executable instructions; and one or more processors configured to execute the computer-executable instructions and cause the processing system to perform a method in accordance with any one of Clauses 1-16.

Clause 18: A system, comprising means for performing a method in accordance with any one of Clauses 1-16.

Clause 19: A non-transitory computer-readable medium comprising computer-executable instructions that, when executed by one or more processors of a processing system, cause the processing system to perform a method in accordance with any one of Clauses 1-16.

Clause 20: A computer program product embodied on a computer-readable storage medium comprising code for performing a method in accordance with any one of Clauses 1-16.

Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, the term “connected to”, in the context of sharing electronic signals and data between the elements described herein, may generally mean in data communication between the respective elements that are connected to each other. In some cases, elements may be directly connected to each other, such as via one or more conductive traces, lines, or other conductive carriers capable of carrying signals and/or data between the respective elements that are directly connected to each other. In other cases, elements may be indirectly connected to each other, such as via one or more data busses or similar shared circuitry and/or integrated circuit elements for communicating signals and data between the respective elements that are indirectly connected to each other.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method, comprising:
receiving first sensor data from a first sensor and second sensor data from a second sensor, wherein the first sensor data and the second sensor data each indicate detected objects in a space;
transforming the first sensor data using a first transformation profile to convert the first sensor data to a coordinate frame of the second sensor data; and
refining the first transformation profile based on a difference between the transformed first sensor data and the second sensor data.

2. The method of claim 1, further comprising prior to transforming the first sensor data, filtering one or more detected objects from the first sensor data based on one or more filtering criteria.

3. The method of claim 2, wherein the filtering criteria specifies a position of detected objects.

4. The method of claim 1, further comprising subsequent to transforming the first sensor data, matching a first detected object in the transformed first sensor data to a second detected object in the second sensor data using one or more matching techniques.

5. The method of claim 4, wherein matching the first detected object to the second detected object is performed using a Hungarian algorithm.

6. The method of claim 4, wherein matching the first detected object to the second detected object is performed upon determining that the first detected object and the second detected object both correspond to a single object.

7. The method of claim 1, wherein refining the first transformation profile comprises:
computing a loss between the transformed first sensor data and the second sensor data; and
using gradient descent to refine the first transformation profile.

8. The method of claim 7, wherein computing the loss comprises computing a distance between a first object in the transformed first sensor data and a second object in the second sensor data.

9. The method of claim 1, further comprising:
generating a first track based on a location of a first object in two or more frames of the transformed first sensor data;
generating a second track based on a location of the first object in two or more frames of the second sensor data;
determining a time offset based on the first and second tracks; and
further refining the first transformation profile based on the time offset.

10. The method of claim 1, wherein the first transformation profile comprises at least one of:
a time offset,
a rotation correction,
a translation correction, or
a projection correction.

11. The method of claim 1, further comprising:
receiving third sensor data from a third sensor; and
transforming the third sensor data using a second transformation profile to convert the third sensor data to the coordinate frame of the second sensor data.

12. The method of claim 1, wherein the first sensor and second sensor are associated with a vehicle, and wherein the detected objects in the space comprise at least one of:
another vehicle,
a pedestrian,
an obstacle, or
a road marking.

13. The method of claim 1, wherein the first sensor and the second sensor are of a plurality of sensors, and wherein the plurality of sensors comprise at least one of:
a light detection and ranging (LIDAR) sensor,
a radio detection and ranging (radar) sensor,
an ultrasonic sensor,
a camera, or
a global positioning sensor.

14. The method of claim 1, wherein detected objects in the first sensor data are characterized by bounding boxes indicating, for each detected object, one or more of:
a size,
a position,
a rotation, or
a confidence value.

15. A processing system, comprising:
a memory comprising computer-executable instructions; and
one or more processors configured to execute the computer-executable instructions and cause the processing system to perform an operation comprising:
receiving first sensor data from a first sensor and second sensor data from a second sensor, wherein the first sensor data and the second sensor data each indicate detected objects in a space;
transforming the first sensor data using a first transformation profile to convert the first sensor data to a coordinate frame of the second sensor data; and
refining the first transformation profile based on a difference between the transformed first sensor data and the second sensor data.

16. The processing system of claim 15, the operation further comprising: prior to transforming the first sensor data, filtering one or more detected objects from the first sensor data based on one or more filtering criteria.

17. The processing system of claim 15, the operation further comprising subsequent to transforming the first sensor data, matching a first detected object in the transformed first sensor data to a second detected object in the second sensor data using one or more matching techniques.

18. The processing system of claim 17, wherein matching the first detected object to the second detected object is performed using a Hungarian algorithm.

19. The processing system of claim 15, wherein refining the first transformation profile comprises:
computing a loss between the transformed first sensor data and the second sensor data; and
using gradient descent to refine the first transformation profile.

20. The processing system of claim 19, wherein computing the loss comprises computing a distance between a first object in the transformed first sensor data and a second object in the second sensor data.

21. The processing system of claim 15, the operation further comprising:
generating a first track based on a location of a first object in two or more frames of the transformed first sensor data;
generating a second track based on a location of the first object in two or more frames of the second sensor data;
determining a time offset based on the first and second tracks; and
further refining the first transformation profile based on the time offset.

22. The processing system of claim 15, the operation further comprising:
receiving third sensor data from a third sensor; and
transforming the third sensor data using a second transformation profile to convert the third sensor data to the coordinate frame of the second sensor data.

23. A non-transitory computer-readable medium comprising computer-executable instructions that, when executed by one or more processors of a processing system, cause the processing system to perform an operation comprising:
receiving first sensor data from a first sensor and second sensor data from a second sensor, wherein the first sensor data and the second sensor data each indicate detected objects in a space;
transforming the first sensor data using a first transformation profile to convert the first sensor data to a coordinate frame of the second sensor data; and
refining the first transformation profile based on a difference between the transformed first sensor data and the second sensor data.

24. The non-transitory computer-readable medium of claim 23, the operation further comprising: prior to transforming the first sensor data, filtering one or more detected objects from the first sensor data based on one or more filtering criteria.

25. The non-transitory computer-readable medium of claim 23, the operation further comprising subsequent to transforming the first sensor data, matching a first detected object in the transformed first sensor data to a second detected object in the second sensor data using one or more matching techniques.

26. The non-transitory computer-readable medium of claim 25, wherein matching the first detected object to the second detected object is performed using a Hungarian algorithm.

27. The non-transitory computer-readable medium of claim 23, wherein refining the first transformation profile comprises:
computing a loss between the transformed first sensor data and the second sensor data; and
using gradient descent to refine the first transformation profile.

28. The non-transitory computer-readable medium of claim 27, wherein computing the loss comprises computing a distance between a first object in the transformed first sensor data and a second object in the second sensor data.

29. The non-transitory computer-readable medium of claim 23, the operation further comprising:
generating a first track based on a location of a first object in two or more frames of the transformed first sensor data;
generating a second track based on a location of the first object in two or more frames of the second sensor data;
determining a time offset based on the first and second tracks; and
further refining the first transformation profile based on the time offset.

30. A processing system, comprising:
means for receiving first sensor data from a first sensor and second sensor data from a second sensor, wherein the first sensor data and the second sensor data each indicate detected objects in a space;
means for transforming the first sensor data using a first transformation profile to convert the first sensor data to a coordinate frame of the second sensor data; and
means for refining the first transformation profile based on a difference between the transformed first sensor data and the second sensor data.
